(19) United States
(12) Patent Application Publication
(10) Pub. No.: US 2009/0095171 A1
(43) Pub. Date: Apr. 16, 2009

(54) ELECTRIC PRESS DEVICE

(76) Inventors: Shoji Futamura, Kanagawa (JP); Keizo Unno, Kanagawa (JP)

Correspondence Address: MCGLEW & TUTTLE, PC, P.O. BOX 9227, SCARBOROUGH STATION, SCARBOROUGH, NY, 10510-9227, US

(21) Appl. No.: 10/596,023

(22) PCT Filed: Aug. 1, 2005
(86) PCT No.: PCT/JP2005/014023

§ 371 Date: May 25, 2006

(30) Foreign Application Priority Data
Aug. 18, 2004 (JP) 2004-238270

(51) Int. Cl. B30B 1/18

(52) U.S. Cl. 100/289; 100/299

(57) ABSTRACT

An object of the present invention is to provide an electric press device which enables fixed-point working requiring accurate position control with a high accuracy for a long time by changing a structure in a publicly known document in which a differential key is moved in a straight state to a structure of circumferential movement. In an electric press device for performing fixed-point working on a work piece by vertically moving a slide plate (5) by a first motor (8), a cylindrical nut elevating sleeve (15) having a helically advancing sliding groove (21) on the outer circumferential face, a nut elevating plate (17) having a guide engagement portion (22) fitted in the sliding groove to move slidingly and a second motor (41) for rotationally moving the nut elevating plate (17) are provided as a differential mechanism.

### TECHNICAL FIELD

The present invention relates to an electric press device used for sheet metal working and the like, and more particularly, to an electric press device in which fixed-point working requiring accurate position control in micron units is performed with a mechanism for reciprocating a presser in the vertical direction, for example, by ball screw engagement using a ball screw shaft driven by a motor and its nut portion.

### BACKGROUND ART

As a conventional electric press device in which a presser is vertically moved by ball screw engagement using a ball screw shaft driven by a motor and its nut portion, the applicant has already proposed the electric press device described in the patent document 1 and the patent document 2.

FIG. 17 is a longitudinal sectional front view of an essential part of the conventional electric press device, and FIG. 18 is a sectional plan view of an essential part on arrow X-X in FIG. 17. FIGS. 17 and 18 show the constitution disclosed in the patent document 1.

In FIGS. 17 and 18, reference numeral 10 denotes a substrate formed into a rectangular flat state, for example, and guide bars 20 are stood at its four corners. At the upper ends of these guide bars 20, a support plate 30 formed into a rectangular flat state is fixed via fastening members 33.

Next, reference numeral 40 is a screw shaft supported capable of normal and reverse rotations at the center part of the support plate 30 via a bearing 34 and penetrating the support plate 30. Reference numeral 50 is a movable body and is engaged with the above guide bars 20 movably in the axial direction. Reference numeral 31 is a spindle motor provided on the support plate 30 and drives the movable body 50 by rotating the screw shaft 40. Reference numeral 60 is a nut member, in which a nut portion 62 having a flange portion 61 and the above screw shaft 40 are screwed together by ball screw engagement, and a male thread 64 for differential is provided on the outer circumferential face of a cylinder portion 63 to which the nut portion 62 is fastened.

Reference numeral 65 is a differential member formed in a hollow cylindrical state and has a female thread 66 for differential to be screwed with the above male thread 64 for differential provided on its inner circumferential face. Reference numeral 67 is a worm wheel formed to be integrally fastened to the above differential member 65 and engaged with a worm gear 68.

A worm shaft is inserted into and fastened to the center part of the worm gear 68, and the worm shaft is provided capable of rotation by bearings provided at its both ends within the movable body 50.

Reference numeral 91 is a presser and reference numeral 92 is a placing table, which is detachably provided on the lower surface at the center part of the above movable body 50. The spindle motor 31 and a motor 69 are constituted capable of control and driving by application of a predetermined signal through a control means, not shown.

By the above constitution, when a predetermined signal is supplied to the spindle motor 31 to be operated, the screw shaft 40 is rotated, the movable body 50 provided with the nut member 60 is lowered, the presser 91 is lowered from an initial height H⁰ to a fixed-point working height H, fixed-point working is conducted on a work piece W, and after completion of the working, the movable body 50 is raised by reverse operation of the spindle motor 31, and the presser 91 is returned to the position of the initial height H⁰. Measurement of the values of the above height H⁰ and H and control of the motor 31 are performed by measuring means and control means, not shown. Such working operation is called as fixed-point working.

When the above fixed-point working has reached the predetermined number of times, or at every fixed-point working, operation of the spindle motor 31 is stopped at the position shown in FIG. 17, that is, the position of the initial height H⁰ of the presser 91, and a preset signal is supplied to the motor 69 for rotating the differential member 65. By this, the motor 69 is rotated by a predetermined angle, and the differential member 65 is rotationally moved only by a predetermined angle via the worm gear 68 and the worm wheel 67. By this rotational motion of the differential member 65, the nut member 60 is stopped and locked, that is, the female thread 66 for differential is rotated with respect to the stopped male thread 64 for differential, which causes the movable body 50 to be displaced.

By the displacement of the movable body 50, the initial height H⁰ of presser 91 is also changed as a matter of course, but if the screw shaft 40 is left to be rotated, predetermined fixed-point working can not be performed. Therefore, next, some controlled signals are supplied to the spindle motor 31 so as to slightly rotate the screw shaft 40, and the displacement of the above movable body 50 and the presser 91 is offset so that the initial height H⁰ of the presser 91 is kept constant.

By the above rotational motion of the screw shaft 40, the relative positions of the screw shaft 40 and the nut portion 62 are changed. That is, the relative positions of a ball and a ball groove formed in the ball screw engagement can be changed, local wear of the ball and/or ball groove can be prevented while fixed-point working is ensured, and fixed-point working can be performed ongoingly thereafter.

It is needless to say that the operation by the spindle motor 31 to offset displacement of the position of the movable body 50, which has been described referring to FIG. 17, is performed in a no-load state where pressing by the presser 91 is not conducted.

FIG. 19 is a block diagram of the conventional electric press device and FIG. 20 is a sectional view of an essential part showing the movable body and the differential key. FIGS. 19 and 20 show the constitution described in the patent document 2.

Reference numerals 10, 20, 30, 31, 33, 40, 62, 91, 92, W in FIGS. 19 and 20 correspond to those in FIGS. 17 and 18. And reference numeral 51 denotes a slide plate, reference numeral 70 for a movable device, reference numeral 71 for a first movable body, reference numeral 72 for a second movable body, reference numeral 73 for a differential key, reference numeral 74 for a driving screw shaft, reference numeral 75 for a pulse motor, reference numeral 76 for a support member, reference numeral 77 for a guide plate, reference numeral 78 for a mounting member, reference numeral 79 for a guide groove, reference numeral 80 for a slant face portion, reference numeral 81 for a projected rim integrally provided on the side portion of the differential key 73, reference numeral 82 for a recess groove provided within the first movable body 71 and the second movable body 72, reference numeral 83 for a slant face portion provided within the first movable body 71 and formed having the same inclination angle as that of the slant face portion 80, reference numeral 84 for a bottom face portion of the differential key 73 and reference numeral 85 for a horizontal support face provided within the second movable body 72, respectively.

In the constitution corresponding to the patent document 2 shown in FIGS. 19 and 20, the relative positions of the screw shaft 40 and the nut portion 62 are changed after a single or plural fixed-point working as with the constitution corresponding to the patent document 1.

By the above constitution in FIGS. 19 and 20, when the predetermined pulse number is applied to the motor 31 in FIG. 19 to start operation, the screw shaft 40 is rotated, the movable device 70 comprising the first movable body 71, the second movable body 72 and the differential key 73 connecting them to each other is lowered, the presser 91 is lowered from the initial height H₀ to the fixed-point working height H, the fixed-point working is performed on the work piece W, and after completion of the working, the movable device 70 is raised by the reverse operation of the motor 31 and the presser 91 is returned to the position of the initial height H₀.

When the above fixed-point working has been conducted once or reached the predetermined number of times, or at every fixed-point working, operation of the motor 31 is stopped at the position of the initial height H₀ of the presser 91, and the preset pulse number is applied to the pulse motor 75. By this, the pulse motor 75 is rotated only for the predetermined number of times, and the differential key 73 is slightly moved in the horizontal direction via the driving screw shaft 74. By this movement of the differential key 73, the first movable body 71 and the second movable body 72 are relatively moved in the vertical direction, and the position of the movable device 70 is displaced. A corrective operation to offset this displacement is, as with the one shown in FIG. 17, performed by application of some pulse number to the motor 31 so that the initial height H₀ of the presser 91 is kept constant.

By rotational motion of the screw shaft 40 accompanying the above correction, the relative positions of the screw shaft 40 and the nut portion 62 are changed, and the relative positions of the ball and the ball groove formed in the ball screw engagement can be changed and thus, local wear of the ball and/or ball groove can be prevented while fixed-point working is ensured, and fixed-point working can be performed ongoingly thereafter.

Patent document 1: Japanese Patent Laid-Open No. 2000-218395

Patent document 2: Japanese Patent Laid-Open No. 2002-144098

### DISCLOSURE OF THE INVENTION

### Problem to be Solved by the Invention

In the constitution shown in the patent document 1, since the conventional differential mechanism in which the screw shaft 40 is slightly rotated as above so as to offset the displacement of the movable body 50 and the presser 91 and to keep the initial height H₀ of the presser 91 constant uses screw engagement between the male thread 64 for differential and the female thread 66 for differential, the relative positions of the ball and the ball groove can be changed to micron and the change amount per cycle can be kept uniform with a high accuracy. On the other hand, however, use of the above screw engagement makes mechanical dimension of the screw engagement relatively fine, and there is a room for improvement when a strong pressure works while mechanical strength is fully maintained.

In the mean time, in the constitution shown in the patent document 2, since the first movable body 71 and the second movable body 72 vertically holding the wedge-shaped differential key 73 between them are separate from each other, the structure for holding the both in the vertical direction, that is, the constitution including the guide plate 77, the mounting member 78 and the guide groove 79 shown in FIG. 20 leaves room for improvement.

The present invention was made in view of the above points, and the object thereof is to provide an electric press device which enables fixed-point working requiring accurate position control with a high accuracy for a long time by changing the structure in which the differential key 73 shown in the patent document 2 is moved in a straight state to the structure of so-called circumferential movement.

### Means for Solving the Problem

Therefore, the electric press device according to the present invention having a substrate formed in a flat-plate state;

a plurality of guide bodies provided with one ends crossed with the substrate at a right angle;

a flat-plate state support body provided at the other ends of the guide bodies in a manner to cross with the guide bodies at a right angle;

a slide plate provided slidably between the substrate and the support body while being guided by the guide bodies;

a first motor for driving the slide plate slidably with respect to the guide bodies;

a ball screw shaft connected to an output shaft of the first motor and rotatably borne in parallel with the guide bodies with respect to the support body, and

a connecting mechanism provided with a nut member to be screwed with the ball screw shaft and a differential mechanism having an upper end fastened to the nut member and a lower end to the slide plate for slightly changing the contact position between the ball screw shaft as well as a thread groove within the nut member and the ball housed in the nut member, and

in the structure that the slide plate is vertically moved by normal and reverse rotations of the ball screw shaft driven by the first motor for performing fixed-point working on a work piece placed on the substrate, characterized in that

the differential mechanism of the above connecting mechanism comprises:

a cylindrical nut elevating sleeve having a helically advancing sliding groove provided on the outer circumferential face;

a nut elevating plate having an annular portion with a worm wheel tooth provided on the outer circumferential face and a guide engagement portion to be fitted in and slidably engaged with the sliding groove of the nut elevating sleeve provided on the inner circumferential face;

a worm meshed with the worm wheel tooth and capable of normal and reverse rotations;

a housing body with the bottom surface fastened to the slide plate for housing a nut elevating assembly rotatably bearing the worm and constituted by fitting the guide engagement portion of the nut elevating plate in the sliding groove of the nut elevating sleeve, for housing the nut elevating plate capable of rotational motion of the annular portion of the nut elevating plate in the form that the movement in the axial direction is constrained and for housing the nut elevating sleeve in the form that the nut elevating sleeve is slidable in the axial direction and constrained in its radial direction, and

a second motor for driving the worm capable of normal and reverse rotations.

Also, the electric press device is further characterized in that the guide engagement portion provided at the above nut elevating plate has a substantially U-shaped section with upper and lower two flat surfaces and a perpendicular surface connecting the two flat surfaces, and

the sliding groove provided at the above nut elevating sleeve is comprised by a substantially U-shaped groove corresponding to the above upper and lower two flat surfaces and the above perpendicular surface of the guide engagement portion provided at the above nut elevating plate.

### EFFECT OF THE INVENTION

Since the present invention has the above-mentioned structure, when the elevating plate is rotationally moved around the central axis, the guide engagement portion provided at the elevating plate advances through the helically advancing sliding groove provided at the elevating sleeve, and the elevating sleeve is caused to move slightly upward or downward in response to it. Therefore, when the elevating plate is rotationally moved, the elevating sleeve receives a pressing force with respect to the central axis. That is, the pressing force acts to the central axis of the nut member all the time.

Also, since the guide engagement portion provided at the elevating plate and the sliding groove provided at the elevating sleeve are in substantial contact with each other on three surfaces, there is no undesired rattle between the elevating plate and the elevating sleeve. And the guide engagement portion and the sliding groove form a mechanically robust structure.

### BRIEF DESCRIPTION OF THE DRAWINGS

FIG. 1 is a partially sectional front view of a preferred embodiment of an essential part of an electric press device according to the present invention;

FIG. 2 is a detail view of a differential mechanism expressed as a view on arrow A-A in FIG. 1;

FIG. 3 is a detail view of a differential mechanism expressed as a view on arrow B-B in FIG. 2;

FIG. 4 is a right-side view of FIG. 2;

FIG. 5 is an exploded perspective view of a preferred embodiment before assembling of a nut elevating sleeve and a nut elevating plate;

FIG. 6 is a plan view of a preferred embodiment of the nut elevating sleeve;

FIG. 7 is a sectional view expressed as a view on arrow C-C in FIG. 6;

FIG. 8 is a sectional view expressed as a view on arrow D-D in FIG. 6;

FIG. 9 is a right-side view of a preferred embodiment of the nut elevating sleeve;

FIG. 10 is a back-side view of a preferred embodiment of the nut elevating sleeve;

FIG. 11 is a plan view of a preferred embodiment of the nut elevating plate;

FIG. 12 is a sectional view of the nut elevating plate;

FIG. 13 is a sectional view of the nut elevating plate in another direction;

FIG. 14 is an explanatory view showing the state of a ball existent between a ball screw shaft and a nut member;

FIG. 15 is a detail view of another preferred embodiment of a differential mechanism corresponding to FIG. 3;

FIG. 16 is a detail view of another preferred embodiment of a differential mechanism corresponding to FIG. 2;

FIG. 17 is a longitudinal sectional front view of an essential part of a conventional electric press device;

FIG. 18 is a sectional plan view of an essential part on arrow X-X in FIG. 17;

FIG. 19 is a block diagram of the conventional electric press device; and

FIG. 20 is a sectional view of an essential part showing a movable body and a differential key.

### DESCRIPTION OF SYMBOLS

1: Substrate
2: Guide bar
3: Support plate
5: Slide plate
6: Presser
7: Table
8: Motor (first motor)
9: Ball screw shaft
12: Connecting mechanism
13: Nut member
14: Differential mechanism
15: Nut elevating sleeve
16: Housing body
17: Nut elevating plate
18: Worm
19: Worm wheel tooth
21: Sliding groove
22: Guide engagement portion
44: Notch portion

### BEST MODE FOR CARRYING OUT THE INVENTION

An electric press device according to the present invention will be described.

### Example 1

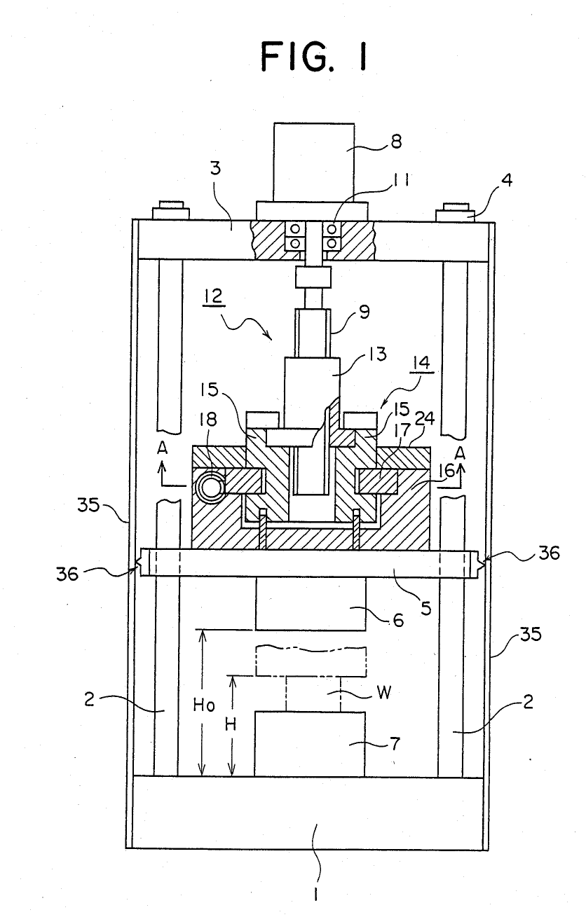

FIG. 1 shows a partially sectional front view of a preferred embodiment of an essential part of an electric press device according to the present invention.

In FIG. 1, reference numeral 1 is a substrate formed into a rectangular flat-plate state, for example, and columnar guide bars (guide bodies) 2 are stood at its four corners. At the upper ends of these guide bars 2, a support plate 3 formed into a rectangular flat-plate state is fastened via fastening members 4.

Numeral reference 5 is a slide plate provided to form sliding engagement with the guide bar 2 and capable of vertical sliding and has a presser 6 fastened to the lower part. Reference numeral 7 is a table provided on the substrate 1 for allowing a work piece W to be loaded thereon.

The support plate 3 has a motor (first motor) 8 having an encoder built-in, and to its shaft, a ball screw shaft 9 supported in parallel with the guide bars 2 is rotatably connected via a thrust bearing 11 provided at the support plate 3.

The support plate 3 and the slide plate 5 freely sliding on the guide bars 2 are in the structure connected by a connecting mechanism 12. That is, the connecting mechanism 12 is provided with a nut member 13 screwed with the ball screw shaft 9 and a differential mechanism 14 for slightly changing the contact position between the ball screw shaft 9 and a ball built in the nut member 13, in which the lower end of the nut member 13 is fastened to the upper end of the differential mechanism 14 and the lower end of the differential mechanism 14 is fixed to the slide plate 5, and the above support plate 3 and the slide plate 5 are connected by screw engagement between the ball screw shaft 9 rotatably borne with respect to the support plate 3 and the nut member 13.

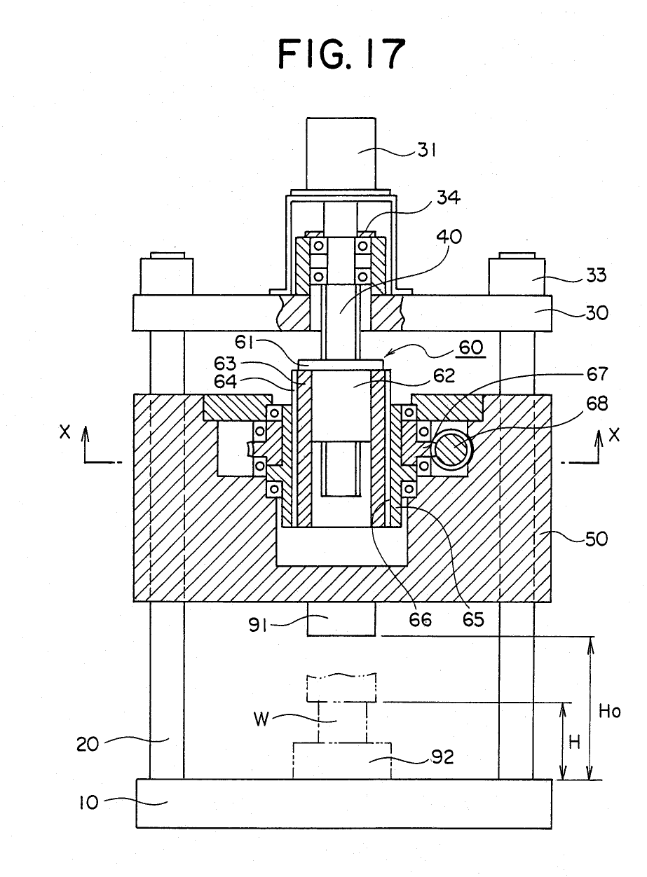

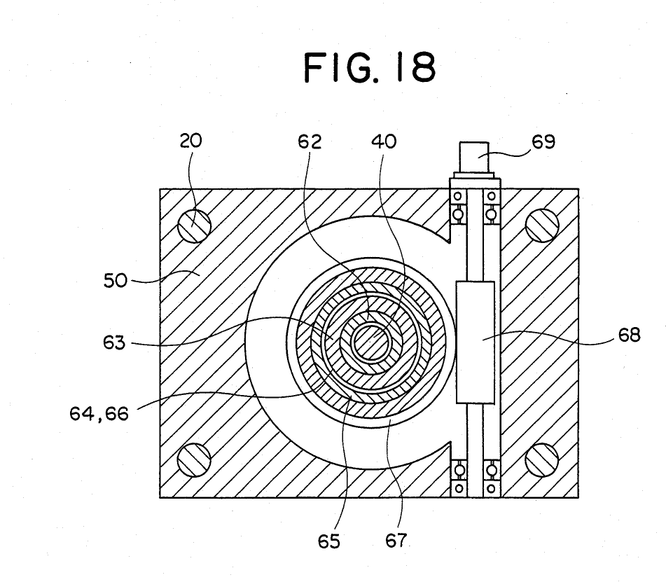

By the connecting mechanism 12 in such a structure, the slide plate 5 is raised or lowered by normal rotation/reverse rotation of the ball screw shaft 9 driven by the motor 8 capable of driving in the forward and reverse directions so as to vertically reciprocate the slide plate 5 by appropriate rotation control of the motor 8, and by the presser 6 provided at the lower end of the slide plate 5, fixed-point working can be applied to the work piece W loaded on the substrate 1, that is, the table 7 of the substrate 1, as explained referring to FIG. 17.

The above differential mechanism 14 is provided with a nut elevating sleeve 15 to which the nut member 13 is fastened, a housing body 16 housing the nut elevating sleeve 15 in the protruded form in the direction of the nut member 13, a nut elevating plate 17 for slightly moving the nut elevating sleeve 15 in its axial direction by being engaged with the nut elevating sleeve 15 and the housing body 16 for rotational motion, and a worm 18 for rotationally moving the nut elevating plate 17.

### Example 2

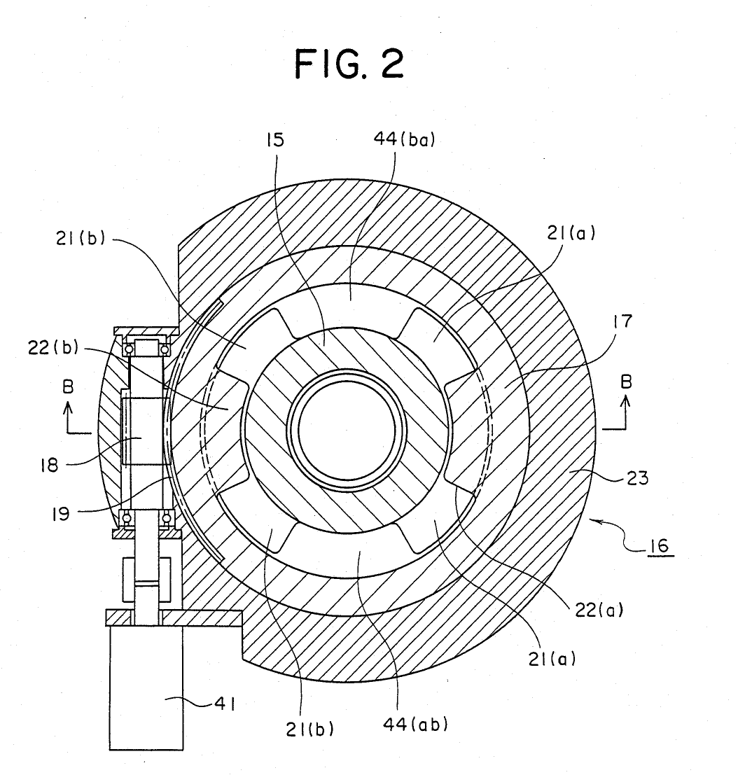

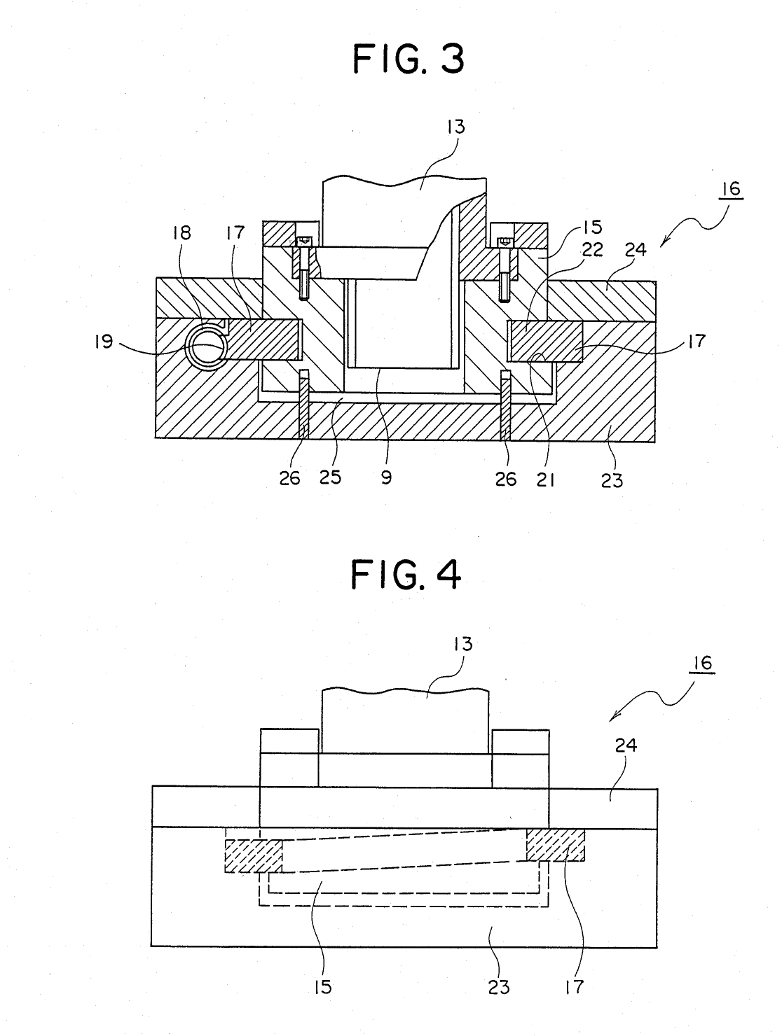

FIGS. 2 and 3 show detail views of the differential mechanism, FIG. 2 being a view on arrow A-A in FIG. 1 and FIG. 3 being a view on arrow B-B in FIG. 2. Reference numerals correspond to those in FIG. 1.

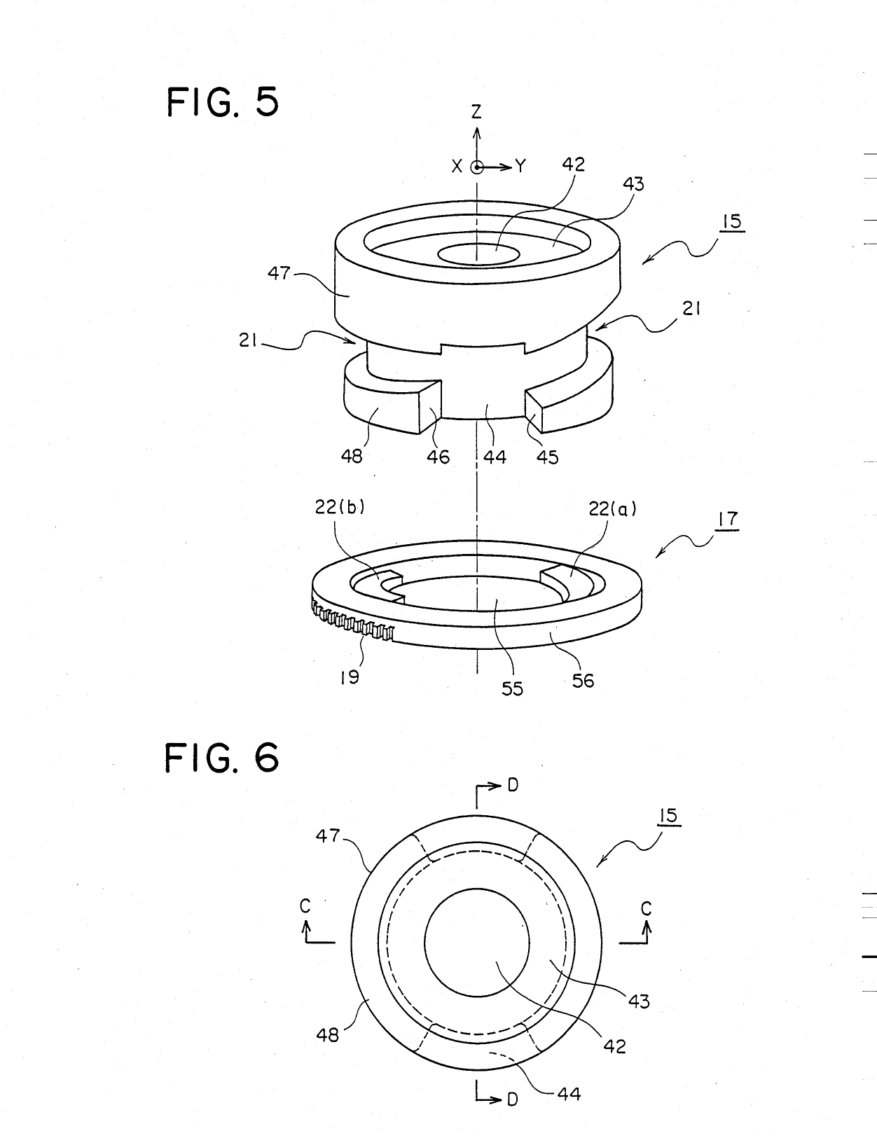

On the nut elevating plate 17 is provided a worm wheel tooth 19 to mesh with the worm 18 provided at the housing body 16. Also, a helical state sliding groove 21 (see FIG. 5 showing the angle of the sliding groove 21 in the exaggerated manner) advancing at a slight angle is provided at the center part on the outer circumferential face of the nut elevating sleeve 15, and on the inner circumferential face of the nut elevating plate 17 is provided a guide engagement portion 22 (see FIG. 5 showing the angle of the guide engagement portion 22 in the exaggerated manner) to form sliding engagement with the sliding groove 21 advancing helically on this nut elevating sleeve 15.

The housing body 16 is formed by a housing member 23 and a ring member 24, in which the housing member 23 rotatably bears the above worm 18 and has a stepped hole 25 drilled at the center part and an annular space formed by the step of the hole 25 and the ring member 24 fastened to the upper face of the housing member 23. And in this annular space, the nut elevating plate 17 engaged with and fitted in the above helically advancing sliding groove 21 provided on the nut elevating sleeve 15 is housed capable of rotational motion in the form constrained in the axial direction of the ball screw shaft 9. Also, the ring member 24 supports the outer circumferential face of the nut elevating sleeve 15 slidably in the axial direction of the ball screw shaft 9 so as to house the nut elevating sleeve 15.

When the worm 18 is rotated, the nut elevating plate 17 is rotationally moved via the worm wheel tooth 19 meshed with the worm 18, and the guide engagement portion 22 is rotationally moved. That is, the guide engagement portion 22 is rotationally moved along the helically advancing sliding groove 21 provided on the nut elevating sleeve 15, and the nut elevating sleeve 15 is slightly moved in its axial direction, that is, in the vertical direction.

Each of the structures of the nut elevating sleeve 15 on which the sliding groove is formed, the nut elevating plate 17 provided with the worm wheel tooth 19 and the guide engagement portion 22 and the housing body 16 will be described later in detail.

Between the substrate 1 and the support plate 3, a pulse scale 35 for detecting the position of the slide plate 5, that is, the position of the presser 6 is provided along the four guide bars 2, respectively, and a detection portion 36 for reading the respective pulse scales 35 is provided at the corresponding position of the slide plate 5, respectively. The fixed-point working is performed based on a position detection signal of the slide plate 5 obtained by this pulse scale 35 and the detection portion 36.

When the fixed-point working has reached the predetermined number of times, or at every fixed-point working, operation of the motor 8 is stopped at the position of the initial height H₀ of the presser 6, and the preset number of pulse-state voltage, for example, is applied to a motor 41 (see FIG. 2) for rotating the worm 18. By this, the motor 41 is rotated by a predetermined amount, and the nut elevating sleeve 15 is slightly moved in its axial direction via rotational motion of the nut elevating plate 17. By this movement of the nut elevating sleeve 15, the slide plate 5 is vertically moved via the housing body 16, and the position of the presser 6 is displaced from the above H₀. This displacement is detected by the above pulse scale 35 and the detection portion 36, and some voltage is applied to the motor 8 to offset the displacement so that the initial height H₀ of the presser 6 is kept constant all the time.

By rotational motion of the ball screw shaft 9 accompanying the above correction, the relative positions of the ball screw shaft 9 and the nut member 13 are changed and the relative positions of the ball and the ball groove formed in the ball screw engagement can be changed so that local wear of the ball and/or ball groove can be prevented while fixed-point working is ensured and the fixed-point working can be performed ongoingly thereafter.

The differential mechanism 14 will be described in more detail.

FIG. 2 is a view on arrow A-A in FIG. 1, FIG. 3 is a view on arrow B-B in FIG. 2, FIG. 4 is a right-side view of FIG. 2, and FIG. 5 is an exploded perspective view of a preferred embodiment before assembling of the nut elevating sleeve and the nut elevating plate, respectively.

In FIGS. 2 to 5, the housing body 16 comprised by the nut elevating sleeve 15 and the nut elevating plate 17 housed in the combined form is constituted by the substantially circular housing member 23 with a stepped hole 25 drilled at the center part and the ring member 24 fastened to the upper end face of the housing member 23 after the nut elevating sleeve 15 and the nut elevating plate 17 are housed in the hole 25 in the combined form as shown in FIGS. 3 and 4.

Inside the housing member 23, the worm 18 rotatably borne as shown in FIG. 3 is provided, the worm 18 being so constituted that it is meshed with the worm wheel tooth 19 formed on a part of the outer circumferential face of the nut elevating plate 17 so that the nut elevating plate 17 is rotationally moved by the motor (second motor) 41 mounted at the outside of the housing member 23.

FIG. 5 shows the nut elevating sleeve 15 and the nut elevating plate 17 in the exaggerated manner so that the explanation can be understood easily.

The nut elevating sleeve 15 is shown in FIGS. 6 to 10, and the nut elevating plate 17 is shown in FIGS. 11 to 13.

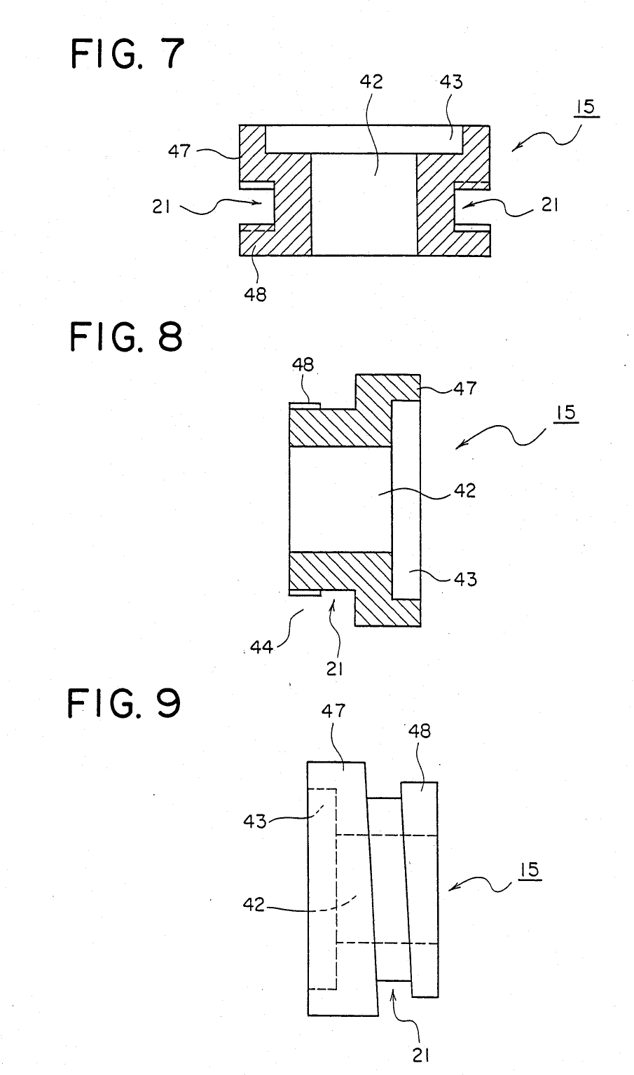

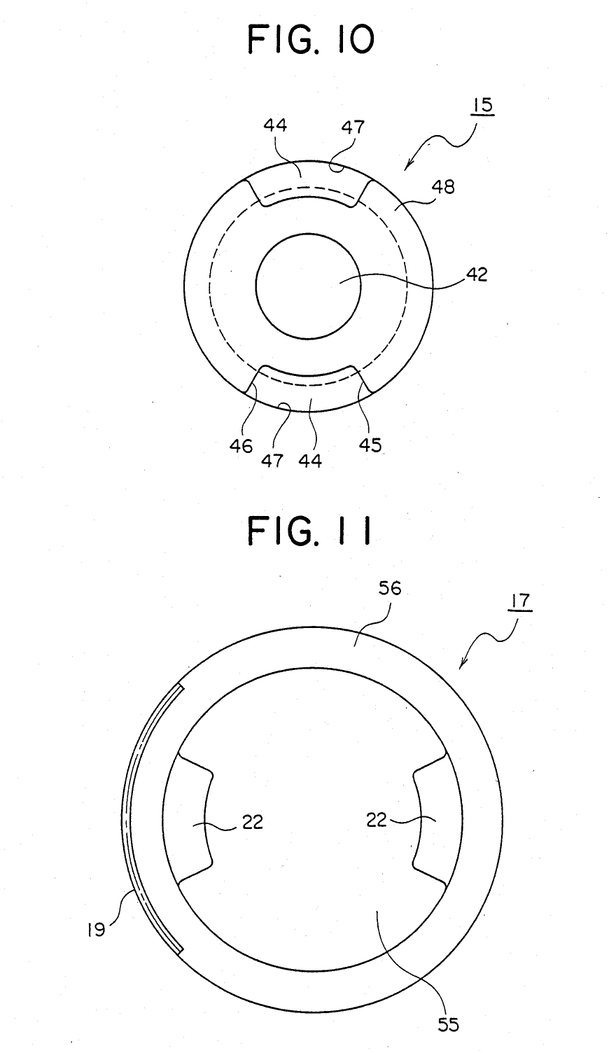

FIG. 6 is a plan view of a preferred embodiment of the nut elevating sleeve, FIG. 7 is a sectional view on arrow C-C in FIG. 6, FIG. 8 is a sectional view on arrow D-D in FIG. 6, FIG. 9 is a right-side view and FIG. 10 is a back-side view, respectively.

The nut elevating sleeve 15 has, as clearly shown also in FIG. 5, an opened hole 42 at the center part and a recess 43 provided in the periphery of the opened hole 42 on the upper face portion. And the entire shape is structured in the cylindrical state with the helically advancing sliding groove 21 formed on the outer circumferential face. There exist an upper annular portion 47 and a lower annular portion 48 divided by the sliding groove 21, and in the lower annular portion 48, a notch portion 44 is provided in which the guide engagement portion 22 in the nut elevating plate 17 is fitted, as will be described later. In the case of the illustrated preferred embodiment, since there are two guide engagement portions 22 in the nut elevating plate 17, there are two notch portions 44 provided. At the right and left ends of the notch portion 44, ends 45 and 46 are shown.

The helically advancing formation of the sliding groove 21 existent between the upper annular portion 47 and the lower annular portion 48 is clearly illustrated in FIG. 7 shown as a sectional view on arrow C-C in FIG. 6. In the lower annular portion 48, the state where two notch portions 44, 44 exist is clearly illustrated in FIG. 10 shown as a back-side view.

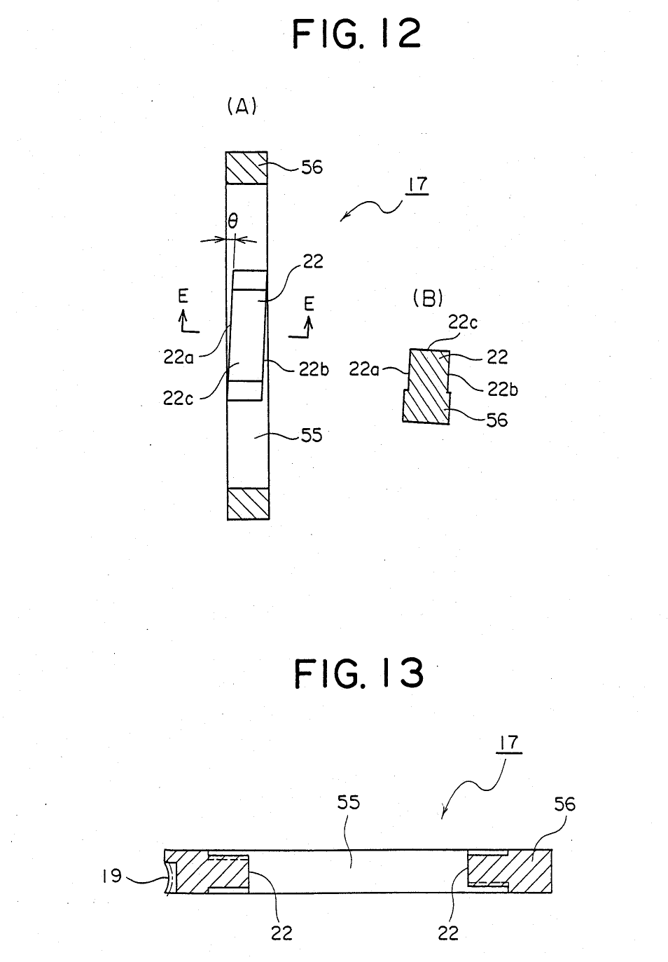

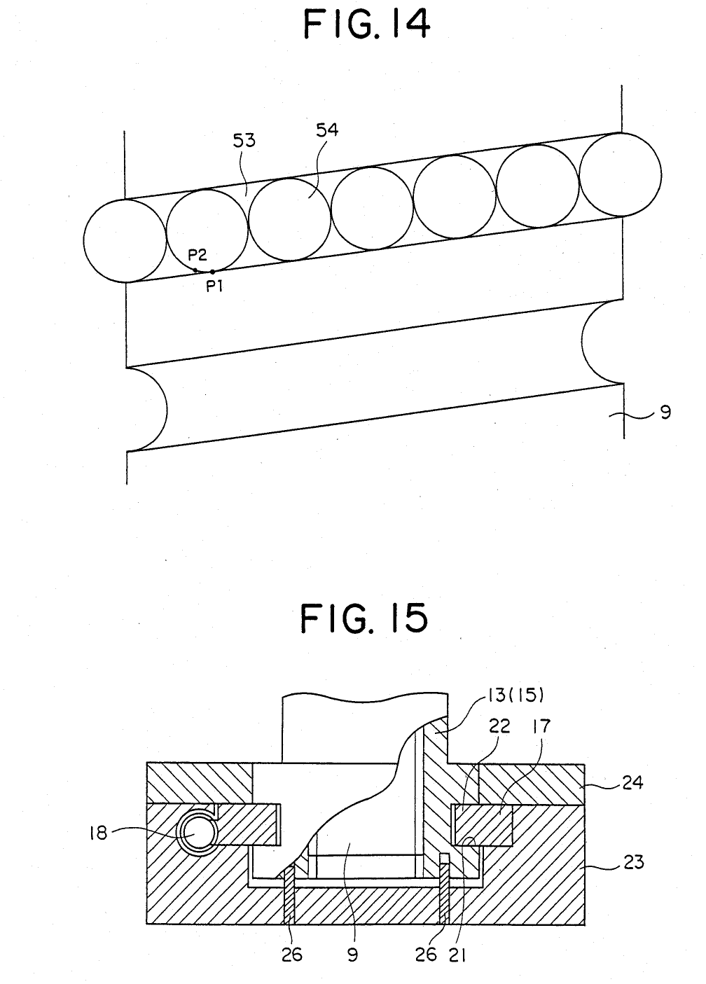

The nut elevating plate 17 is shown in FIGS. 11 to 13. FIG. 11 is a plan view of a preferred embodiment of the nut elevating plate, FIG. 12(A) is a sectional view of a part where the guide engagement portion 22 in FIG. 11 does not exist, FIG. 12(B) is a sectional view on arrow E-E in FIG. 12(A), and FIG. 13 is a sectional view of a part where the guide engagement portion 22 in FIG. 11 exists, respectively.

The nut elevating plate 17 has, as clearly shown also in FIG. 5, an opened hole 55 at the center part, the entire shape is formed in the annular state and the worm wheel tooth 19 is provided on a part of the outer circumference in an annular portion 56. Also, on the circumferential face of the annular portion 56, two guide engagement portions 22, 22 are provided in the illustrated case.

The guide engagement portions 22, 22 are formed so that they can be rotationally moved in the sliding groove 21 while being closely engaged with the helically advancing sliding groove 21 in the nut elevating sleeve 15. The state where the guide engagement portions 22, 22 are provided on the inner circumferential face of the annular portion 56 with an inclination angle θ corresponding to the inclined face of the above sliding groove 21, respectively, is clearly illustrated in FIG. 12(A). The section of the guide engagement portion 22 is formed in the U-shape, and the guide engagement portion 22 has two upper and lower flat surfaces 22a, 22b and a perpendicular surface 22c connecting these flat surfaces 22a, 22b. This state is clearly illustrated in FIG. 12(B).

The U-shaped section in the guide engagement portion 22 corresponds to the sectional shape of the sliding groove 21 (not shown) in the above-mentioned nut-elevating sleeve 15. By this constitution, undesired rattle between the nut elevating plate 17 and the nut elevating sleeve 15 is prevented when the nut elevating plate 17 is rotationally moved within the sliding groove 21 in the nut elevating sleeve 15, and mechanical strength of the guide engagement portion 22 can be ensured.

When the nut elevating plate 17 is to be engaged with the nut elevating sleeve 15, the guide engagement portions 22, 22 in the nut elevating plate 17 are made to correspond to the notch portions 44, 44 in the nut elevating sleeve 15 and pressed onto the upper annular portion 47 side in the nut elevating sleeve 15 so as to be rotationally moved along the sliding groove 21 in the nut elevating sleeve 15. By engaging the both with each other in this way, the housing body 16 shown in FIG. 2 is formed.

As clearly shown in FIG. 2, the nut elevating sleeve 15 has two notch portions 44, 44, and the sliding grooves 21, 21 are formed between the two notch portions 44, 44. In FIG. 2, a sliding groove 21(a) exists between notch portions 44(ab) and 44(ba), while a sliding groove 21(b) exists between the notch portions 44(ba) and 44(ab). And the guide engagement portion 22(a) in the nut elevating plate 17 is engaged with the sliding groove 21(a), while the guide engagement portion 22(b) is engaged with the sliding groove 21(b). And corresponding to the rotational motion of the motor 41, the two guide engagement portions 22(a) and 22(b) of the nut elevating plate 17 are rotationally moved along the two sliding grooves 21(a) and 21(b) in the nut elevating sleeve 15, respectively.

Since the sliding grooves 21(a), 21(b) in the nut elevating sleeve 15 are formed so as to advance in the helical state as mentioned above in correspondence to the rotational motion of the nut elevating plate 17, the nut elevating sleeve 15 is slightly moved upward or downward with respect to the housing member 23. Pins 26, 26 shown in FIG. 3 are to prohibit rotational motion of the nut elevating sleeve 15 with respect to the housing member 23 along the axis and to allow upward or downward movement with respect to the axis.

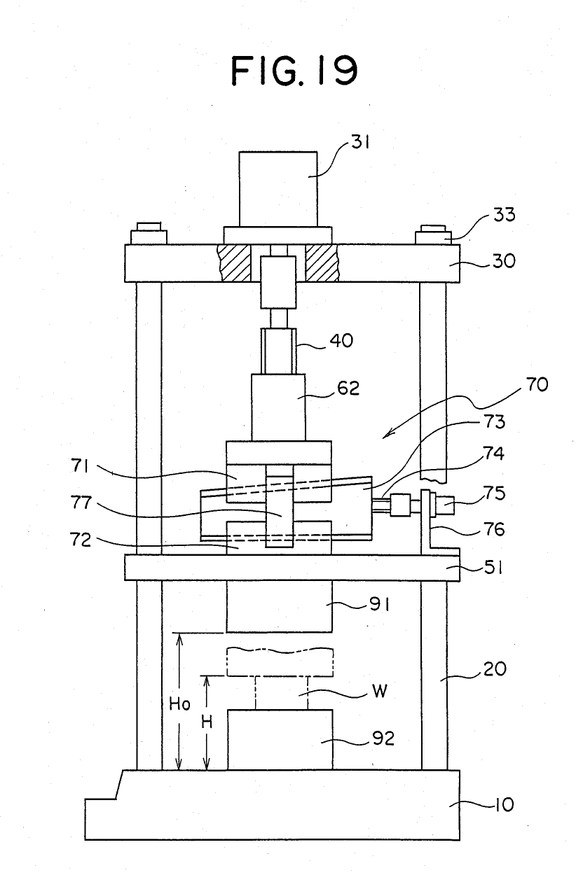

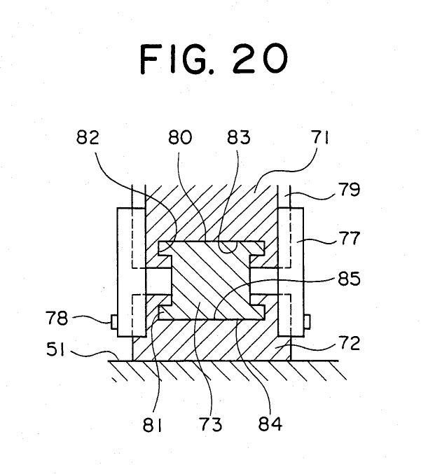

The state where the guide engagement portion 22 in the nut elevating plate 17 is rotationally moved within the helical sliding groove 21 in the nut elevating sleeve 15 corresponds to the horizontal movement in FIG. 19 of the differential key 73 between the first movable body 71 and the second movable body 72 in FIG. 19 shown as a conventional constitution. In the case of the constitution shown in FIG. 3 of the present application, however, in response to the rotational motion of the nut elevating plate 17, the nut elevating sleeve 15 receives a force upward or downward along the central axis via the sliding groove 21 concentrically existing with respect to the central axis.

Since the nut elevating sleeve 15 is slightly moved upward or downward in this way, the initial height H₀ of the presser 91 is slightly changed as with the conventional constitution shown in FIG. 17 or FIG. 19. The motor 8 is rotationally moved slightly so as to correct this change and controlled so that the initial height H₀ of the presser 91 is maintained. By this control, the ball screw shaft 9 is rotationally moved slightly within the nut member 13, and balls 54 are rotationally moved slightly as shown in FIG. 14.

FIG. 14 is an explanatory diagram showing the state of the balls existing between the ball screw shaft and the nut member. Reference numeral 9 in this Figure denotes a ball screw shaft, reference numeral 54 for a ball and reference numeral 53 for a ball groove in the ball screw shaft. It is needless to say that there exists a similar ball groove on the side of the nut member 13.

If a pressure has been applied to the ball 54 and the groove 53 at a pressing point P1 shown in FIG. 14 at a single or the predetermined number of times of fixed-point working, the correction operation by the motor 8 performed in correspondence to the above-mentioned upward or downward movement of the nut elevating sleeve 15 causes the pressing point P1 to be moved as with the conventional constitution shown in FIG. 17 or FIG. 19. For example, the point is moved to the point P2 in the ball 54 so that local wear of the ball and/or ball groove can be prevented.

### Example 3

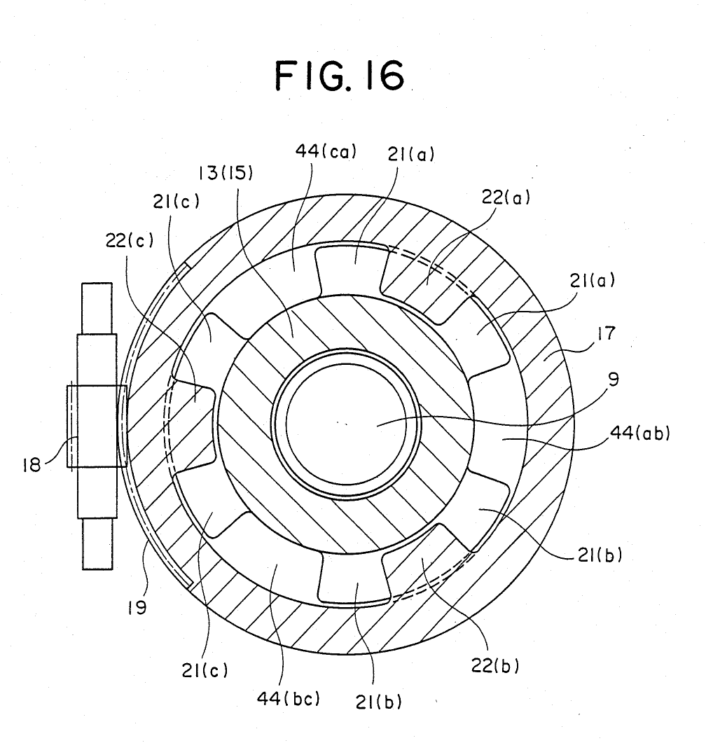

FIGS. 15 and 16 show another preferred embodiment of the differential mechanism, wherein FIG. 15 is a view corresponding to FIG. 3 and FIG. 16 is a view corresponding to FIG. 2.

Reference numerals 9, 13(15), 17, 18, 19, 21, 22, 23, 24, 26, 44 in Figures correspond to those in FIG. 2 or FIG. 3.

In the case of the preferred embodiment shown in FIGS. 15 and 16, a difference from the preferred embodiment shown in FIGS. 2 and 3 is substantially the following two points.

One of them is that the nut member 13 and the nut elevating sleeve 15 shown in FIGS. 2 and 3 are constituted as an integral article. And the other is that three of those corresponding to the guide engagement portion 22 in the nut elevating plate 17 shown in FIGS. 2 and 3 exist with a 120-degree interval, three of those corresponding to the notch portion 44 in the nut elevating sleeve 15 exist with a 120-degree interval, and those corresponding to the sliding groove 21 is separated into three parts by the notches.

The structure and functions in the case of the preferred embodiment shown in FIGS. 15 and 16 are basically the same as those shown in FIGS. 2 and 3, whose detailed description will be omitted, but since the nut member 13 and the nut elevating sleeve 15 are produced as an integral article, screwing for connecting the nut member 13 and the nut elevating sleeve 15 to each other is not needed any more. Also, since there are three guide engagement portions 22, the force to move the nut elevating sleeve 15 upward or downward acts from a position with a good balance with 120 degrees away with respect to the central axis of the nut elevating sleeve 15.

### INDUSTRIAL APPLICABILITY

In an electric press device having a ball screw shaft and a nut portion, fixed-point working can be performed while undesired local wear at the ball screw shaft, balls and the nut portion is prevented. Also, change of the contact position between the ball and the nut portion to the micron is performed by operation between rotating systems, and the change amount can be maintained uniform with a high accuracy.

1. An electric press device having a substrate formed in a flat-plate state;
a plurality of guide bodies each provided in such a manner that one ends thereof is crossed with the substrate at a right angle;
a flat-plate state support body provided at the other ends of the guide bodies in a manner to cross with the guide bodies at a right angle;
a slide plate provided slidably between the substrate and the support body while being guided by the guide body;
a first motor for driving the slide plate slidably with respect to the guide bodies;
a ball screw shaft connected to an output shaft of the first motor and rotatably borne in parallel with the guide bodies with respect to the support body, and
a connecting mechanism provided with a nut member to be screwed with the ball screw shaft and a differential mechanism having an upper end fastened to the nut member and a lower end to the slide plate for slightly changing the contact position between the ball screw shaft as well as a thread groove within the nut member and the ball housed in the nut member, and
in the structure that the slide plate is vertically moved by normal and reverse rotations of the ball screw shaft driven by the first motor for performing fixed-point working on a work piece placed on the substrate, characterized in that
the differential mechanism of said connecting mechanism comprises:
a cylindrical nut-elevating sleeve having a helically advancing sliding groove provided on the outer circumferential face;
a nut elevating plate having an annular portion with a worm wheel tooth provided on the outer circumferential face and a guide engagement portion to be fitted in and slidably engaged with the sliding groove of the nut elevating sleeve provided on the inner circumferential face;
a worm meshed with the worm wheel tooth and capable of normal and reverse rotations;
a housing body with the bottom surface fastened to the slide plate for housing a nut elevating assembly rotatably bearing the worm and constituted by fitting the guide engagement portion of the nut elevating plate in the sliding groove of the nut elevating sleeve, for housing the nut elevating plate capable of rotational motion of the annular portion of the nut elevating plate in the form that the movement in the axial direction is constrained and for housing the nut elevating sleeve in the form that the nut elevating sleeve is slidable in the axial direction and constrained in its radial direction, and
a second motor for driving the worm capable of normal and reverse rotations.

2. The electric press device according to claim 1, wherein the guide engagement portion provided at said nut elevating plate has a substantially U-shaped section with upper and lower two flat surfaces and a perpendicular surface connecting the two flat surfaces, and
the sliding groove provided at said nut elevating sleeve is comprised by a substantially U-shaped groove corresponding to said upper and lower two flat surfaces and said perpendicular surface of the guide engagement portion provided at said nut elevating plate.
